(19) United States
(12) Patent Application Publication
(10) Pub. No.: US 2009/0207340 A1
(43) Pub. Date: Aug. 20, 2009

(54) LIQUID CRYSTAL DISPLAY DEVICE

(76) Inventors: Jin-Seok Jang, Suwon-si (KR); Duk-Woon Choi, Suwon-si (KR); Won-Mi Hwang, Suwon-si (KR)

Correspondence Address: CHRISTIE, PARKER & HALE, LLP, PO BOX 7068, PASADENA, CA, 91109-7068, US

(21) Appl. No.: 12/251,986

(22) Filed: Oct. 15, 2008

(30) Foreign Application Priority Data
Feb. 20, 2008 (KR) 10-2008-0015397

(51) Int. Cl. G02F 1/13357

(52) U.S. Cl. 349/65

(57) ABSTRACT

A liquid crystal display device including a liquid crystal display panel on which an image is displayed; first and second polarizing plates each attached to upper and lower surfaces of the liquid crystal display panel; a lamp emitting light; a light guide plate guiding light from the lamp to the liquid crystal display panel; and a prism sheet disposed between the light guide plate and the liquid crystal display panel and having a plurality of prism bulges arranged in a surface thereof, the prism bulges having a predetermined pitch, wherein an arrangement direction of the prism bulges on the prism sheet is cross to the transmission axis of the second polarizing plate at a predetermined angle to the transmission axis.

### CROSS-REFERENCE TO RELATED APPLICATION

This application claims priority to and the benefit of Korean Patent Application No. 10-2008-0015397, filed on Feb. 20, 2008, in the Korean Intellectual Property Office, the entire content of which is incorporated herein by reference.

### BACKGROUND OF THE INVENTION

1. Field of the Invention

The present invention relates to a liquid crystal display device, and more particularly to an improved liquid crystal display device for obtaining maximum optical efficiency.

2. Description of Related Art

A liquid crystal display device is a display device which uses the modulation of light by liquid crystal cells, converting a certain orientation of liquid crystal molecules into a different orientation by applying a voltage to the liquid crystal molecules and changing optical properties of liquid crystal cells, such as birefringence, optical rotatory power, and optical scattering property, into visual properties, the liquid crystal cells emitting light on the orientation of the liquid crystal molecules.

Unlike organic light emitting display devices (OLEDs), cathode ray tubes (CRTs), light emitting diodes (LEDs) that autonomously generate light, the liquid crystal display device does not emit light by itself but uses an external light.

That is to say, the liquid crystal display device is a non-emissive device that displays an image by controlling the amount of light received from the outside environments. Therefore, the liquid crystal display device requires an additional backlight unit as a power source to provide light to a liquid crystal display panel with the light.

However, such a liquid crystal display device has a problem in that only 7% of light generated in the backlight unit actually reaches a screen while penetrating the generated light through cells, i.e., a pixel region, of the liquid crystal display device.

Therefore, there is a need for an improved liquid crystal display device that maximize its optical efficiency to provide high luminance.

### SUMMARY

The present invention is a liquid crystal display device capable of improving the optical efficiency by disposing a prism sheet having prism bulges, which is provided in a backlight unit of the liquid crystal display device, cannot accord with a transmission axis of a polarizing plate that corresponds to the prism sheet.

One embodiment of the present invention is a liquid crystal display device includes a liquid crystal display panel where an image is displayed; first and second polarizing plates each attached to upper and lower surfaces of the liquid crystal display panel; a lamp to emit the light; a light guide plate for guiding light from the lamp to the liquid crystal display panel; and a prism sheet disposed between the light guide plate and the liquid crystal display panel and having a plurality of prism bulges arranged on a surface thereof, the prism bulges having a predetermined pitch, wherein an arrangement direction of the prism bulges on the prism sheet crosses the transmission axis of the second polarizing plate at a predetermined angle.

The prism sheet may include a pair of prism sheets (a first prism sheet and a second prism sheet) that are arranged with the prism bulges thereon being arranged perpendicular to each other.

Also, the second prism sheet may be disposed between the first prism sheet and the second polarizing plate, and the predetermined angle between the arrangement direction of the prism bulges on the second prism sheet and the transmission axis of the second polarizing plate may range from 110° to 130° in a counterclockwise direction starting from the arrangement direction of the prism bulges on the second prism sheet.

In addition, a second plurality of the prism bulges having a predetermined pitch may be formed on an upper region of the light guide plate, the prism sheet may be a reverse prism sheet whose prism bulges are disposed to face light guide plate, and the prism bulges of the prism sheet and the prism bulges formed on the light guide plate may be arranged perpendicular to each other.

In this case, the predetermined angle between the arrangement direction of the prism bulges on the prism sheet and the transmission axis of the second polarizing plate may range from 90° to 110° in a counterclockwise direction on the basis of the arrangement direction of the prism bulge.

### BRIEF DESCRIPTION OF THE DRAWINGS

The accompanying drawings, together with the specification, illustrate exemplary embodiments of the present invention, and, together with the description, serve to explain the principles of the present invention.

FIG. 1 is a cross-sectional view showing a liquid crystal display device according to a first exemplary embodiment of the present invention.

FIG. 2 is a diagram showing that the transmission axis of a second polarizing plate is cross to the arrangement of the prism bulges in the second prism sheet at an angle according to the first exemplary embodiment shown in FIG. 1.

FIG. 3 is a cross-sectional view showing a liquid crystal display device according to a second exemplary embodiment of the present invention.

FIG. 4 is a diagram showing that the transmission axis of a second polarizing plate is cross to the arrangement angle of the prism bulges in the reverse prism sheet at an angle according to a second exemplary embodiment shown in FIG. 3.

### DETAILED DESCRIPTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the element with one or more intervening elements interposed therebetween. Hereinafter, like reference numerals refer to like elements.

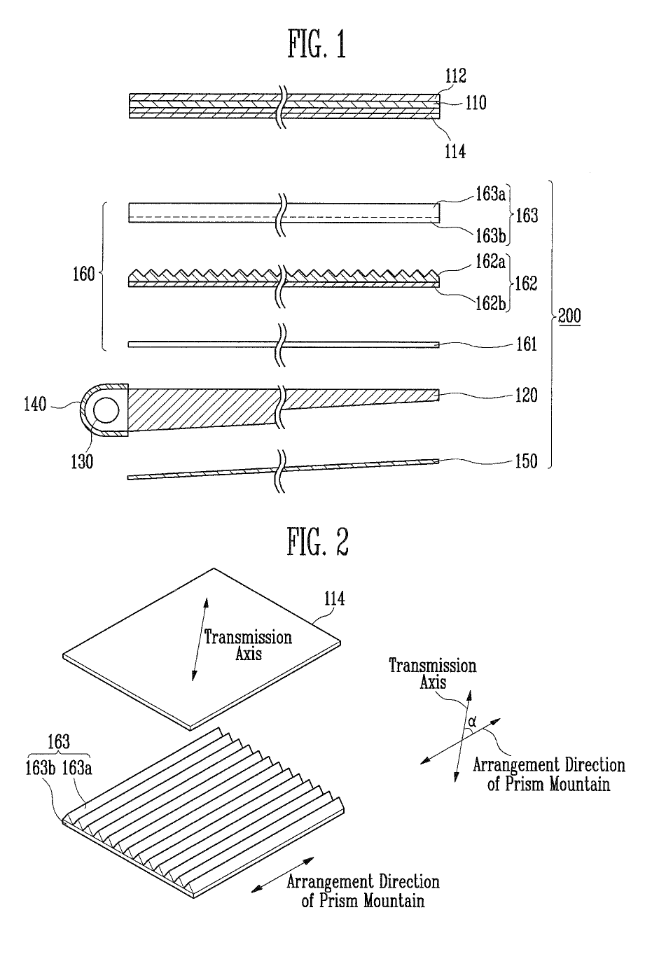

FIG. 1 is a cross-sectional view showing a liquid crystal display device according to a first exemplary embodiment of the present invention.

Referring to FIG. 1, the liquid crystal display device according to the first exemplary embodiment of the present invention includes a liquid crystal display panel 110 for displaying an image and a backlight unit 200 disposed in the rear of the liquid crystal display panel 110 to provide light to the liquid crystal display panel 110.

A first polarizing plate 112 and a second polarizing plate 114 are provided on upper and lower surfaces of the liquid crystal display panel 110, respectively.

Also, the backlight unit 200 includes a lamp 130 as a light source, a light guide plate 120 for guiding light from the lamp 130 to the liquid crystal display panel 110, and a plurality of optical sheets 160 for improving luminance.

The lamp 130 is disposed at a lateral side of the light guide plate 120, and the light emitted from the lamp 130 enters the light guide plate 120 through a lateral surface of the light guide plate 120. Also, a lamp reflecting plate 140 is formed at a lateral side of the light guide plate 120 with the lamp 130 being disposed therebetween. The lamp reflecting plate 140 improves optical efficiency by reflecting some of light from the lamp 130 which does not travel toward the lateral surface of the light guide plate 120, toward the light guide plate 120. Typically, a cold cathode fluorescent lamp (CCFL) is widely used as the lamp 130.

The light guide plate 120 guides the light incident from the lamp 130 toward the liquid crystal display panel 110 disposed in the front of the light guide plate 120. Various patterns such fine dot patterns are printed on the rear surface of the light guide plate 120, the dot patterns functioning to allow the light to progress to the liquid crystal display panel 110.

Typically, a reflecting plate 150 is disposed in the rear of the light guide plate 120 to improve optical efficiency by reflecting the light emitted to the rear of the light guide plate 120 toward the light guide plate 120.

A plurality of optical sheets 160 for improving luminance and optical efficiency are disposed between the light guide plate 120 and the liquid crystal display panel 110.

Each of optical sheets 160 generally includes a diffusion sheet 161, a first prism sheet 162 and a second prism sheet 163.

The diffusion sheet 161 functions to diffuse light from the light guide plate 120 to prevent the concentration of light on a portion, thereby uniformly irradiating light to the liquid crystal display panel 110.

A first prism sheet 162 and a second prism sheet 163 sequentially disposed in the front of the diffusion sheet 161 have a plurality of prism bulges 162a and 163a, respectively formed toward the liquid crystal display panel 110. The prism bulges 162a and 163a have a predetermined pitch. The first prism sheet 162 and the second prism sheet 163 improve the luminance of the liquid crystal display device by collecting the light scattered by the diffusion sheet 161 into the liquid crystal display panel 110.

The prism bulge 162a and the prism bulge 163a, which are formed respectively on the first prism sheet 162 and the second prism sheet 163, are arranged perpendicular to each other, thereby collecting the light from the diffusion sheet 161 in both directions.

Typically, the prism sheets 162 and 163 are produced by coating base layer 162b and 163b, which is formed of PET materials, with an acrylic resin layer and forming prism bulges 162a and 163a thereon.

In prior art liquid crystal display devices, the arrangement of the prism bulges 163a formed on the second prism sheet 163 is formed in parallel to the transmission axis of the second polarizing plate 114 provided in a lower surface of the liquid crystal display panel 110.

That is to say, in the prior art device, direction of the prism bulges 163a on the second prism sheet 163, which is disposed adjacent to the second polarizing plate 114, accords (is in parallel) with the transmission axis of the second polarizing plate 114 provided in a lower surface of the liquid crystal display panel 110, thereby improving the luminance of the liquid crystal display device.

However, empirical measurement results of the incident light for the prior art device show that allowing the arrangement direction of the prism bulge 163a to accord with the transmission axis of the second polarizing plate 114 does not obtain a sufficient optical efficiency for the prism sheet.

In contrast, in the first exemplary embodiment of the present invention, the arrangement direction of the prism bulges 163a does not accord with the transmission axis of the second polarizing plate 114, but the arrangement direction of the prism bulge 163a and the transmission axis of the second polarizing plate 114 are arranged in such a way to cross each other to form a predetermined angle, as shown in FIG. 2. Therefore, it is possible to obtain the maximum transmittance, that is, the maximum optical efficiency for the prism sheet.

In one embodiment, the predetermined angle between the arrangement direction of the prism bulge 163a and the transmission axis of the second polarizing plate 114 ranges from 110° to 130° in a counterclockwise direction starting from the arrangement direction of the prism bulge 163a.

Data as listed in the following Table 1 show the arrangement angles of the prism bulges 162a and 163a on the first prism sheet 162 and the second prism sheet 163, and the luminance of the liquid crystal display corresponding to the arrangement angle when the transmission axis of the second polarizing plate 114 has an angle of 170°.

TABLE 1

| | Arrangement angle of | Arrangement angle | |
|---|---|---|---|
| | prism bulges in | of prism bulges | |
| | second prism sheet | in first prism sheet | Luminance |
| | (degree) | (degree) | (cd/m²) |
| 1 | 0 | 90 | 420 |
| 2 | 10 | 100 | 422 |
| 3 | 20 | 110 | 428 |
| 4 | 30 | 120 | 436 |
| 5 | 40 | 130 | 440 |
| 6 | 50 | 140 | PEAK |
| 7 | 60 | 150 | 440 |
| 8 | 70 | 160 | 430 |
| 9 | 80 | 170 | 414 |

As shown in Table 1, the liquid crystal display device shows the maximum luminance when the prism bulges 163a of the second prism sheet 163 have an arrangement angle of 50° and the transmission axis of the second polarizing plate 114 has an angle of 170°. This result indicates that it is possible to obtain the maximum transmittance, namely the maximum optical efficiency for the prism sheet, by arranging the arrangement direction of the prism bulge 163a and the transmission axis of the second polarizing plate 114 to cross each other at a predetermined angle, for example of 110° to 130°, in a counterclockwise direction starting from the arrangement direction of the prism bulge 163a without allowing the arrangement direction of the prism bulges 163a on the second prism sheet 163 to accord with the transmission axis of the second polarizing plate 114.

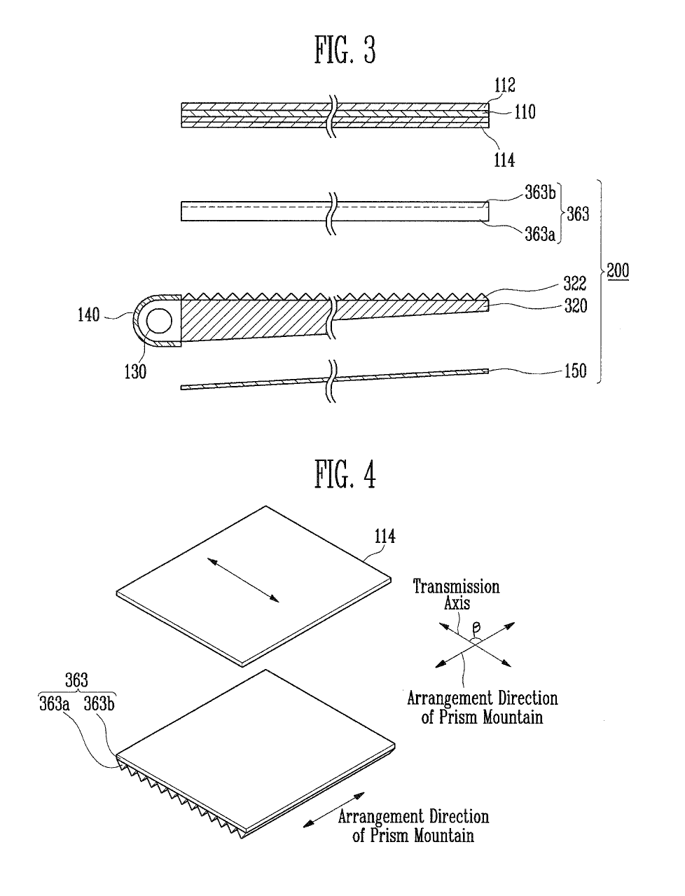

FIG. 3 is a cross-sectional view showing a liquid crystal display device according to a second exemplary embodiment of the present invention.

Comparing the second exemplary embodiment of the present invention as shown in FIG. 3 with the first exemplary embodiment as previously shown in FIG. 1, in the second exemplary embodiment, the first prism sheet 162 and the diffusion sheet 161 are not present in the liquid crystal display device, and a prism bulge 322 is an upper region of the light guide plate 320 to correspond to the absence of the first prism sheet 162 and the diffusion sheet 161, and the second prism sheet 363 is a reverse prism sheet whose prism bulges 363a are arranged in a reverse direction to the prism bulges as previously shown in FIG. 1.

Also, the same components in the first and second exemplary embodiments have the same reference numerals and therefore detailed descriptions of the components are omitted for convenience.

Again, in the prior art liquid crystal display device, the arrangement of the prism bulges 363a formed on the reverse prism sheet 363 was formed in parallel to the transmission axis of the second polarizing plate 114 provided in a lower surface of the liquid crystal display panel 110.

That is to say, in the prior art device, the arrangement direction of the prism bulges 363a in the second prism sheet 363, which is disposed adjacent to the second polarizing plate 114, accords with the transmission axis of the second polarizing plate 114 provided in a lower surface of the liquid crystal display panel 110, thereby improving the luminance of the liquid crystal display device.

However, the measurement results of the incident light for the prior art device shows that to allow the arrangement direction of the prism bulge 363a to accord with the transmission axis of the second polarizing plate 114 does not obtain sufficient optical efficiency for the reverse prism sheet 363.

In contrast, in the second exemplary embodiment of the present invention, the arrangement direction of the prism bulges 363a does not accord with the transmission axis of the second polarizing plate 114, but the arrangement direction of the prism bulge 363a and the transmission axis of the second polarizing plate 114 are arranged in such a way to cross each other to form a predetermined angle, as shown in FIG. 4. Therefore, it is possible to obtain the maximum transmittance, that is, the maximum optical efficiency for the prism sheet.

In one embodiment, the predetermined angle between the arrangement direction of the prism bulge 363a and the transmission axis of the second polarizing plate 114 ranges from 90° to 110° in a counterclockwise direction on the basis of the arrangement direction of the prism bulge 363a.

Data as listed in the following Table 2 show the luminance of the liquid crystal display device according to the angle changes in the transmission axis of the second polarizing plate 114 when an arrangement direction of the prism bulges 363a in the reverse prism sheet 363 has an angle of 0° in relation to the transmission axis of the second polarizing plate 114.

TABLE 2

| Transmission axis | |
|---|---|
| of second polarizing | |
| plate (degree) | Luminance |
| 90 | 5009 |
| 80 | 4931 |
| 70 | 4797 |
| 60 | 4632 |
| 50 | 4492 |
| 40 | 4361 |
| 30 | 4265 |
| 20 | 4191 |
| 10 | 4176 |
| 0 | 4161 |
| 170 | 4321 |
| 160 | 4438 |
| 135 | 4720 |
| 100 | 5036 |
| 90 | 5009 |

As shown in Table 2, the liquid crystal display device shows the maximum luminance when the prism bulges 363a of the reverse prism sheet 363 have an arrangement angle of 50° and the transmission axis of the second polarizing plate 114 has an angle of 100°. This result indicates that it is possible to obtain the maximum transmittance, namely the maximum optical efficiency for the prism sheet, by arranging the arrangement direction of the prism bulge 363a and the transmission axis of the second polarizing plate 114 to cross each other at a predetermined angle, for example of 90° to 110°, in a counterclockwise direction on the basis of the arrangement direction of the prism bulge 363a without allowing the arrangement direction of the prism bulges 363a in the reverse prism sheet 363 to accord with the transmission axis of the second polarizing plate 114.

According to the present invention, the arrangement direction of the prism bulges in the prism sheet provided in the backlight unit of the liquid crystal display device is formed so that it cannot accord with the transmission axis of the polarizing plate corresponding to the prism sheet. Therefore, the liquid crystal display device according to the present invention improves the luminance characteristics by maximizing the optical efficiency.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A liquid crystal display device comprising:
a liquid crystal display panel on which an image is displayed;
first and second polarizing plates each attached to upper and lower surfaces of the liquid crystal display panel, respectively, wherein the second polarizing plate has a transmission axis;
a lamp for emitting light;
a light guide plate for guiding light from the lamp to the liquid crystal display panel; and
a prism sheet disposed between the light guide plate and the liquid crystal display panel and having a plurality of prism bulges arranged in an arrangement direction on a surface thereof, the prism bulges having a predetermined pitch,
wherein the arrangement direction of the prism bulges on the prism sheet crosses the transmission axis of the second polarizing plate at a predetermined angle.

2. The liquid crystal display device according to claim 1, wherein the prism sheet comprises a first prism sheet and a second prism sheet that are arranged with the prism bulges thereon being arranged perpendicular to each other.

3. The liquid crystal display device according to claim 2, wherein the second prism sheet is disposed between the first prism sheet and the second polarizing plate.

4. The liquid crystal display device according to claim 3, wherein the predetermined angle ranges from 110° to 130° in a counterclockwise direction starting from the arrangement direction of the prism bulges on the second prism sheet.

5. The liquid crystal display device according to claim 1, wherein a second plurality of the prism bulges having a predetermined pitch are formed on a surface of the light guide plate facing the liquid crystal display panel.

6. The liquid crystal display device according to claim 5, wherein the prism sheet is a reverse prism sheet and the plurality of prism bulges thereon are disposed to face the light guide plate.

7. The liquid crystal display device according to claim 6, wherein the prism bulges of the prism sheet and the prism bulges formed on the light guide plate are arranged perpendicular to each other.

8. The liquid crystal display device according to claim 6, wherein the predetermined angle ranges from 90° to 110° in a counterclockwise direction starting from the arrangement direction of the prism bulge.
